(19) United States
(12) Patent Application Publication
(10) Pub. No.: US 2015/0350094 A1
(43) Pub. Date: Dec. 3, 2015

(54) METHOD AND SYSTEM OF SETTING NETWORK TRAFFIC FLOW QUALITY OF SERVICE BY MODIFYING PORT NUMBERS

(71) Applicants: RAFIT IZHAK-RATZIN, LOS GATOS, CA (US); KRISHNA SATYASAI YEDDANAPUDI, PLEASANTON, CA (US); SHRAVAN KUMAR VALLALA, SAN JOSE,, CA (US)

(72) Inventors: RAFIT IZHAK-RATZIN, LOS GATOS, CA (US); KRISHNA SATYASAI YEDDANAPUDI, PLEASANTON, CA (US); SHRAVAN KUMAR VALLALA, SAN JOSE,, CA (US)

(21) Appl. No.: 14/288,648

(22) Filed: May 28, 2014

(51) Int. Cl. H04L 12/851; H04L 29/06; H04L 12/741

(52) U.S. Cl. CPC H04L 47/2441; H04L 45/74; H04L 69/22

(57) ABSTRACT

In one exemplary aspect, a method of managing computer network traffic flow quality of service includes the step of configuring a configurable network device to provide a specified quality of service to a data packet with a specified quality of service configuration based on a quality of service classification port number in a data packet header of the data packet. At the source node, a data packet is generated. At the source node, replacing the destination port number in the data packet header with a quality of service classification port number. At the source node, the destination port number is included in an options field of the data packet's header. The data packet is communicated to the configurable network device. At the destination node, receiving the data packet, replacing the quality of service classification port number with the original destination port number, and forwarding the packet to a destination process.

### BACKGROUND

1. Field

This application relates generally to computer networking, and more specifically to a system, article of manufacture and method for setting network traffic flow quality of service (QoS) by modifying port numbers.

2. Related Art

Conventional methods of network services provide Quality of Service (QoS). Few non-limiting examples are based on COS values (layer 2 header) or TOS values (layer 3 header). Intermediate switches and routers can be configured to change these fields based on various parameters, a non-limiting example can be looking at the 5-tuple of the packet. 5-tuple consists of source IP, source port, destination IP, destination port, and protocol. Various network attributes such variable bit rate and delivery time may depend on various current states of the network such as the current traffic load.

Deep packet inspection is another non-limiting option to classify the flow and provide QoS. Intermediate devices (e.g. routers and/or switches) in the network may not be configurable to efficiently inspect the deeper layers of the data packets and provide QoS or priority according to their contents. Moreover, in-line deep packet inspection can increase networking latency, decrease throughput and reduce QoS.

Even if intermediate devices (e.g. routers and/or switches) can support deep packet inspection, customized classifying logic might not be present on these devices. Hence, this may require a customized software loaded on these intermediate devices, which is not very common.

Data packets are segmented when an application utilizes large packet sizes greater than the path MTU (Maximum Transmission Unit). Data packet segmentation can cause the header to be separated from the other segments of the data packet. Thus, conventional attempts to provide a QoS level based on current methods of inspecting data packet headers can be problematic. Accordingly, improvements can be made over conventional methods of setting network traffic flow QoS.

### BRIEF SUMMARY OF THE INVENTION

In one aspect, a method of managing computer network traffic flow quality of service includes the step of configuring a configurable network device to provide a specified quality of service to a data packet with a specified quality of service configuration based on a quality of service classification port number in a data packet header of the data packet. At the source node, a data packet is generated with a destination port number in the data packet header. At the source node, the destination port number in the data packet header is replaced with a quality of service classification port number associated with the specified quality of service. At the source node, the destination port number is included in an options field of the data packet's header. The data packet is communicated to the configurable network device. At a destination node, the data packet can be received. The quality of service classification port number can be replaced with the destination port number in the options field of the data packet header. The data packet can be forwarded to a destination process with the destination port number.

### BRIEF DESCRIPTION OF THE DRAWINGS

The present application can be best understood by reference to the following description taken in conjunction with the accompanying figures, in which like parts may be referred to by like numerals.

FIG. 1 depicts, in block diagram format, a distributed database system with classified traffic flows based on information in the data packet networking headers, according to some embodiments. A non-limiting example for such information can be the 5-tuple of the packet.

FIG. 2 illustrates an example process of enabling traffic flow classification in a database cluster, according to some embodiments.

FIGS. 3 A-B illustrate an example of implementing virtual paths between two nodes in a database cluster, according to some embodiments.

FIG. 4 depicts a process of implementing one or more embodiments provided herein, according to some embodiments.

FIG. 5 depicts a computing system with a number of components that can be used to perform any of the processes described herein.

FIG. 6 shows the TCP header and an expanded view of various sub-fields in the TCP options field of the TCP header, according to some embodiments.

The Figures described above are a representative set, and are not an exhaustive with respect to embodying the invention.

### DETAILED DESCRIPTION

Disclosed are a system, method, and article of setting network traffic flow quality of service (QoS) by modifying port numbers. The following description is presented to enable a person of ordinary skill in the art to make and use the various embodiments. Descriptions of specific devices, techniques, and applications are provided only as non-limiting examples. Various modifications to the examples described herein may be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

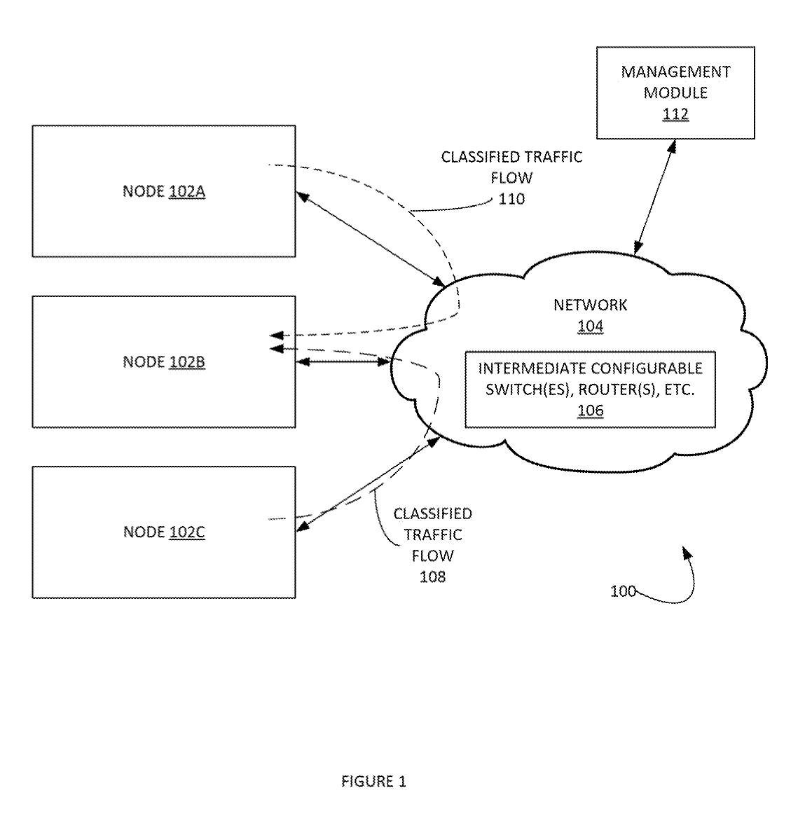

FIG. 1 depicts, in block diagram format, a distributed database system (DDBS) 100 with classified traffic flows based on information in the data packet networking headers, according to some embodiments. DDBS 100 by way of example but not limitation, can include one or more database clusters and their constituent nodes. DDBS 100 by way of example but not limitation, can implement multiple types of traffic flows (refer as classified traffic flows 108 and 110) between nodes 102 A-C. A classified traffic flow can indicate a QoS level to be provided by network 104 to data packets classified accordingly.

Traffic flows 108 and 110 can manage the transmission of a data packets between nodes of DDBS 100 based on a pre-determined QoS classification. By way of example and not limitation, nodes 102 A-C of DDBS 100 can provide information in the data packet's various networking layer headers (e.g. a first segment of a data packet and/or supplemental data at the beginning of a data block). For example, nodes 102 A-C can include an operating system that modifies destination information in the networking layer headers to signify both original source and/or destination ports but also the classification of the traffic flow (e.g. with respect to QoS) of the particular data packet and/or data packet segment.

In some embodiments, the application information layers five to seven may not be visible to the networking devices in network 104 (e.g. not practical to inspect by intermediate configurable switches/routers 106). However, the networking devices can access the 5-tuple information in the networking headers of the data packet. For example, source and/or destination port numbers in the TCP/IP transmission layer header of a data packet can be read by intermediate configurable switches/routers 106. Accordingly, information applicable to classifying traffic flows can be provided to intermediate configurable switches/routers 106 as QoS codes in place of the original destination port numbers provided by the source application(s) in nodes 102 A-C. These QoS classification port numbers can then be used by intermediate device to prioritize various data packets in network 104. In this way, the classification of traffic flows 108 and 110 can be based on information originally located deeper in the data packet (e.g. in layer-5 (L5) to layer-7 (L7) networking headers) without inspection of these layers. Non-limiting examples of these traffic flows can include Hadoop Distributed File System (HDFS) data traffic, iSCSI control traffic, iSCSI data traffic, Thrift protocol message traffic, Cassandra® traffic, Hadoop job tracker traffic, and the like.

Data packets may also be segmented into smaller units (e.g. ‘fragments’) and communicated across network 104. As used herein, data packet segmentation can include the process of dividing a data packet into smaller units for transmission over the network. Since classification of traffic flows 108 and 110 are performed at the source node where the segmentation is also performed, these fragments can also be marked with the same QoS classification port numbers, and can have the same QoS applied as the first segment in the respective traffic flow.

In some embodiments, DDBS 100 can be any distributed data storage system. In some non-limiting examples, DDBS 100 can include a distributed file system (e.g. a clustered filed system such a Hadoop Distributed File System (HDFS), and/or any other distributed file system provided herein). Accordingly, nodes 102 A-C can be implemented as a Hadoop cluster. In still other non-limiting example embodiments, DDBS 100 can include an open source distributed database management system such as Cassandra®. Moreover, in some embodiments, nodes 102 A-C can be implemented as virtual nodes. Indeed, in some example embodiments, DDBS 100 can be implemented as a virtual system in all and/or in part. These examples are provided by way of example and not of limitation.

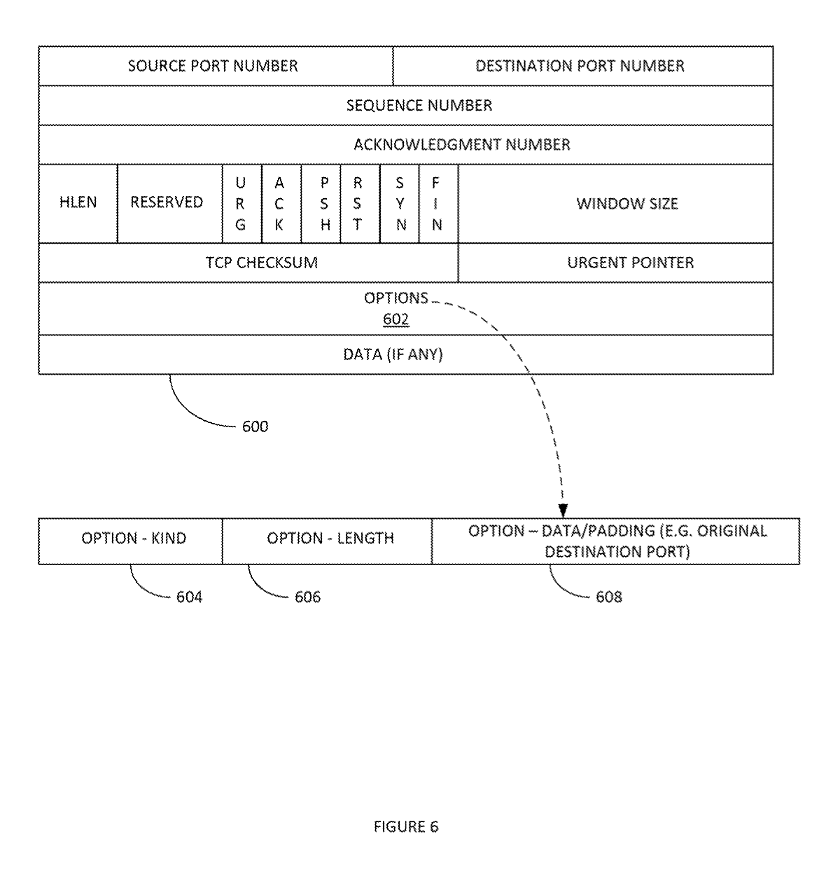

In some embodiments, before sending a data packet, nodes 102 A-C can classify the application payload at the source node TCP/IP layer (e.g. of the TCP/IP model). This classified traffic can be mapped to a different destination port using various techniques. FIG. 6 shows the format of TCP options field. TCP Options have up to three fields: Option-Kind (1 byte), Option-Length (1 byte), Option-Data (variable). A new TCP Option-Kind can be defined to indicate that the replacement of the original destination port number. At the receiving end of the traffic flow, even before the packet is delivered to the TCP/IP layer, the receiving node can include a functionality that identifies the Option-Kind as an indication for a destination port replacement in the TCP/IP header and replaces the destination port in the header used to classify the traffic flow with the original destination port found in the TCP/IP options field. In this way, due to the packet classification at the source node and the mapping to different destination ports, packet inspection by the intermediate network devices 106 can be reduced to a five 5-tuple classification once the packet leaves the source node (e.g. a host).

Accordingly, intermediate network devices 106 can be configured to provide various QoS modes to data packets based on a 5-tuple classification system. TCP/IP packet classification can be done based on 5-tuple (source IP, destination IP, Protocol, source Port, destination port). This information can be available by inspecting up to the layer-4 headers of the packets. Intermediate router(s) and/or switch(es) 106 can inspect these fields and support classification of the data packet in terms of a network QoS mode based on its respective 5-tuples value. The intermediate router(s) and/or switch(es) 106, in turn, can be configurable (e.g. from a management module 112). In this way, different virtual paths (e.g. control paths, data paths, messaging paths, etc.) can be created across the cluster(s) of DDBS 100.

Management module 112 can be used to configure intermediate router(s) and/or switch(es) 106. One non-limiting example may be, a console and/or dashboard can be provided that enables an administrative entity to create various virtual paths in the clusters of DDBS 100. In which certain QoS modes can be matched to a specified the destination port portion of the TCP layer header.

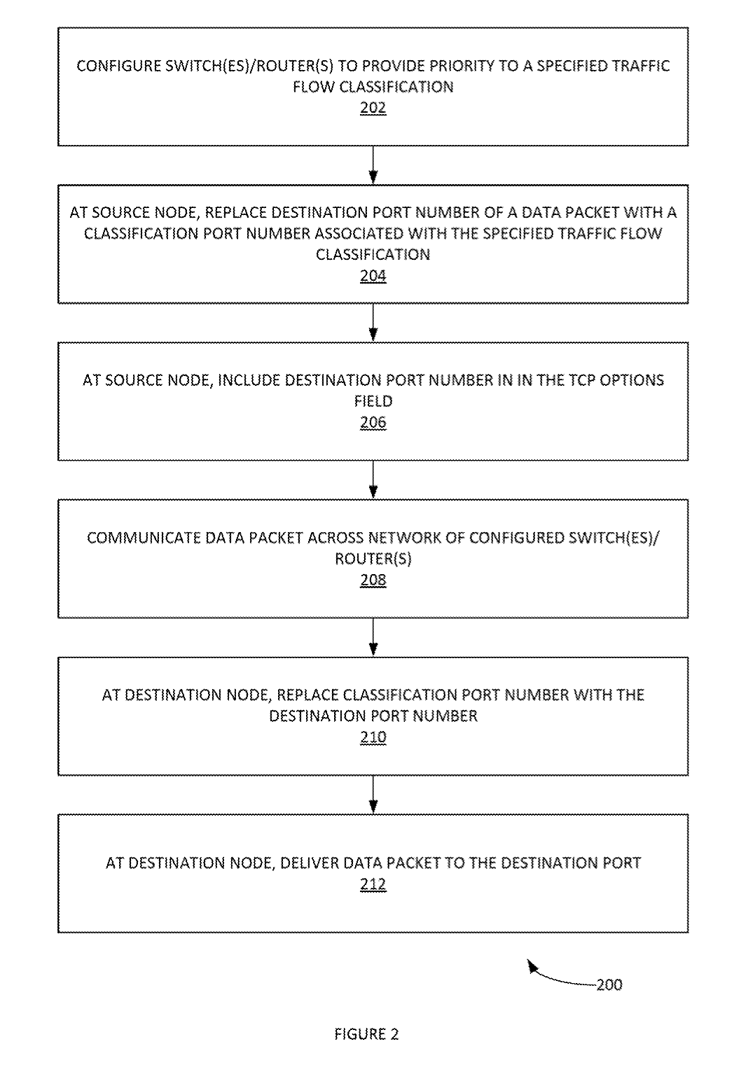

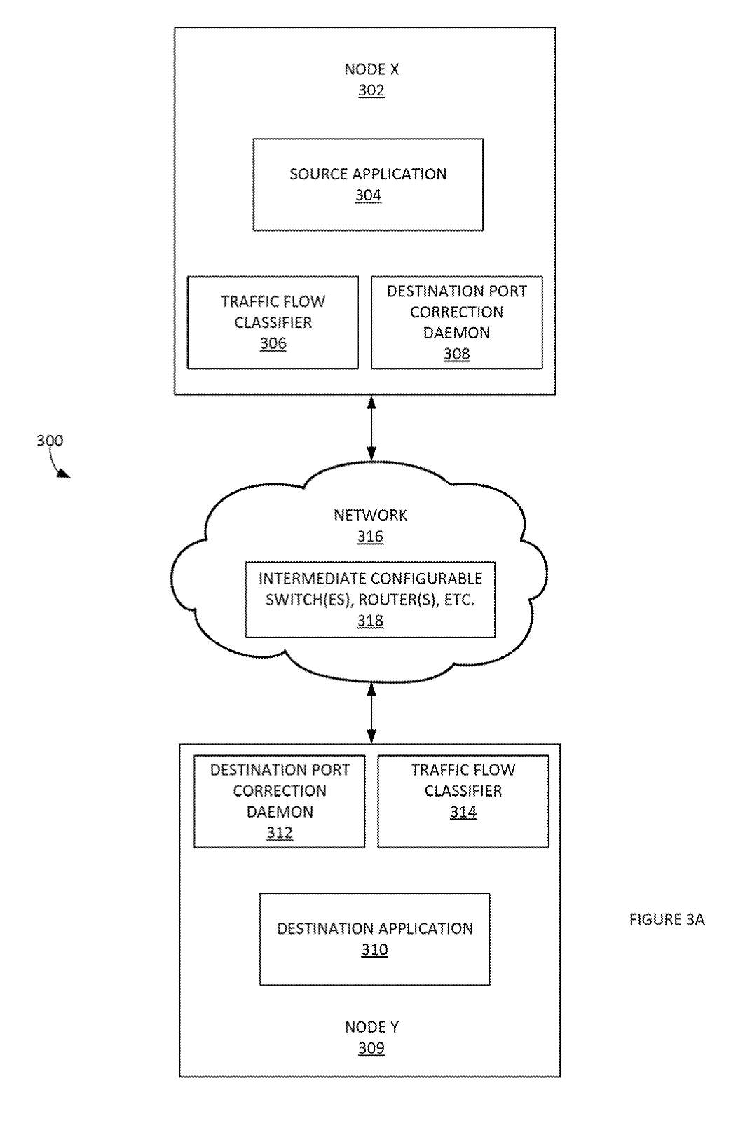

FIG. 2 illustrates an example process 200 of enabling traffic flow classification (e.g. set a network QoS mode) in a database cluster, according to some embodiments. In step 202, the switch(es) and/or router(s) (and/or other network devices) can be configured to provide priority to data packets and/or segments of data packets with a specified traffic flow configuration. A non-limiting example may be an iSCSI control traffic data packet can be prioritized to be communicated over another type of data packet. In step 204, at the source node, the destination port number of the data packet can be replaced with a classification port number associated with the specified traffic flow classification. The classification port number can determine a priority level of the data packet. In step 206, at the source node, the destination port number can be included in the TCP/IP options field. FIG. 6 shows the TCP options field in the TCP header and also format of the options field. In step 208, the data packet can be communicated across a network of configurable switch(es) and/or router(s). The configurable network devices can prioritize the data packet (and/or segments of the data packet) based on the classification port number provided in step 204. In step 210, at the destination node, the classification port number is replaced with the destination port number. For example, a software module or subsystem in the destination host can inspect the TCP options field in the incoming data packets and replace the original destination port number into the data packet header and forward the packet to the correct application in step 212.

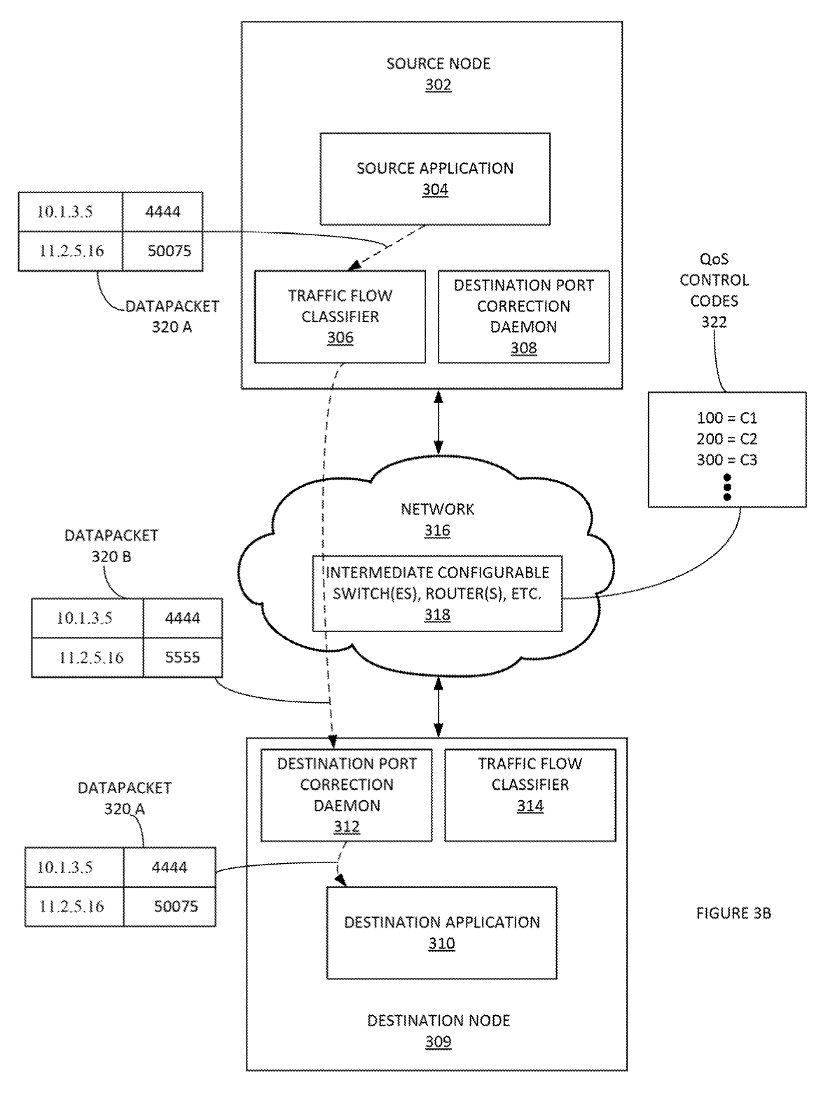

FIGS. 3 A-B illustrate a non-limiting example of a virtual paths implementation between two nodes in a database cluster, according to some embodiments. Node X 302 and/or node Y 309 can be nodes of a database cluster. Node X 302 and/or node Y 309 can be physical nodes and/or virtual nodes. A layer of software can be implemented inside the operating system of node X 302 and/or node Y 309. This software can include traffic flow classifier 306 and/or destination port correction module 308 in node X 302 and/or traffic flow classifier 314 and/or destination port correction module 312 in node Y 309. Node X 302 and/or node Y 309 can also include various applications represented by applications 304 and 310 respectively. Source application 304 can communicate with destination application 310 via a computer networking protocol such as a TCP/IP protocol model. For example, Node X 302 can open a TCP/IP connection with node Y 309. A TCP/IP connection provides a port number(s) and/or IP addresses of node X 302 and/or node Y 309. The non-limiting example, in FIG. 3B, the IP address of node X 302 can be ‘10.1.3.5’ and the IP address of node Y 309 can be ‘11.2.5.16’. The port number for node X can be ‘4444’ and the port number for node Y 309 can be a number should be from the a non-reserved port (e.g. 50075). The source application 304 can bind to these port number(s) and/or IP addresses and communicate data packets to destination application 310 (and vice versa for return data packets from 310 to 304). Accordingly, this information can be included in the data packet 320 A (e.g. in the TCP/IP layer header as discussed supra). Data packet 320 A shows the original source IP address in a top box with source port number at the end. Data packet 320 A shows the original destination IP address in a top box with original destination port number at the end.

Traffic flow classifier 306 (and traffic flow classifier 314) can modify the port number information in the outgoing data packet 320 B. Data packet 320 B shows the original source IP address in a top box with source port number at the end. Data packet 320 B shows the original destination IP address in a top box with QoS classification port number at the end. Traffic flow classifier 306 can provide a new destination port number of ‘5000’. The new destination port number can be used to create a virtual path between node X 302 and node Y 309 in network 316. A non-limiting example nay be, the new destination port number can be provided based on a pre-determined set of QoS control codes 322. The intermediate devices 318 can be configured to provide QoS to data packet 320 B based on QoS control codes 322 (e.g. C1, C2, C3, etc. each representing a predetermined QoS mode). QoS control codes 322 can be defined using a management console.

In this way, virtual paths can be created in network 316 such that the classified traffic flows behave in a deterministic manner. Traffic flow classifier 306 can place the original destination port provided by source application 304 in a TCP/IP options section of the TCP/IP header portion of the data packet 320 B. The TCP/IP protocol can enable a selection of up to four thousand port numbers. Certain number of the ports can be set aside for QoS classification purposes. Thus, when node Y 309 receives the data packet 320 B, destination port correction module 308 can modify data packet 320 B back to its original state as data packet 320 A by replacing the QoS control codes (e.g. ‘5555’) with the original destination port number (e.g. ‘4444’) by consulting the TCP/IP options section. Data packet 320 A can then be provided to destination application 310 which is listening at port 20. It is noted that the networking layer of system 300 (e.g. network 316 and configurable intermediate device 318) need not perform deep packet inspection to determine the QoS classification of the various data packets. Furthermore, source application 304 and destination application 310 do not need to be modified to perform the operations provided in FIGS. 3 A-B. Taking the Hadoop distributed file system as a non-limiting example, system 300 can be adapted to provide different QoS modes for the various Hadoop flows. For example, a C1 QoS classification can be provided to data packets associated with the Hadoop ‘job tracker’ flow. A C2 QoS classification can be provided to data packets associated with the Hadoop ‘task tracker’ flow. A C3 QoS classification can be provided to data packets associated with the Hadoop ‘namenode’ flow. Additional QoS classification can be provided for Hadoop data traffic and the like.

It is noted, that in some embodiments, non-classified and/or external traffic can be accommodated with minimal effect when flowing through an intermediate gateway and/or routers that are configured to act on the classification scheme as provided herein. Additionally, it is noted that the examples provided in FIGS. 3 A-B can be modified in various ways. For example, in some embodiments, the source port number can be modified in lieu of the destination port number. In some embodiments, the headers of other layers of the data packet can be modified. These additional examples are provided by way of explanation and not of limitation.

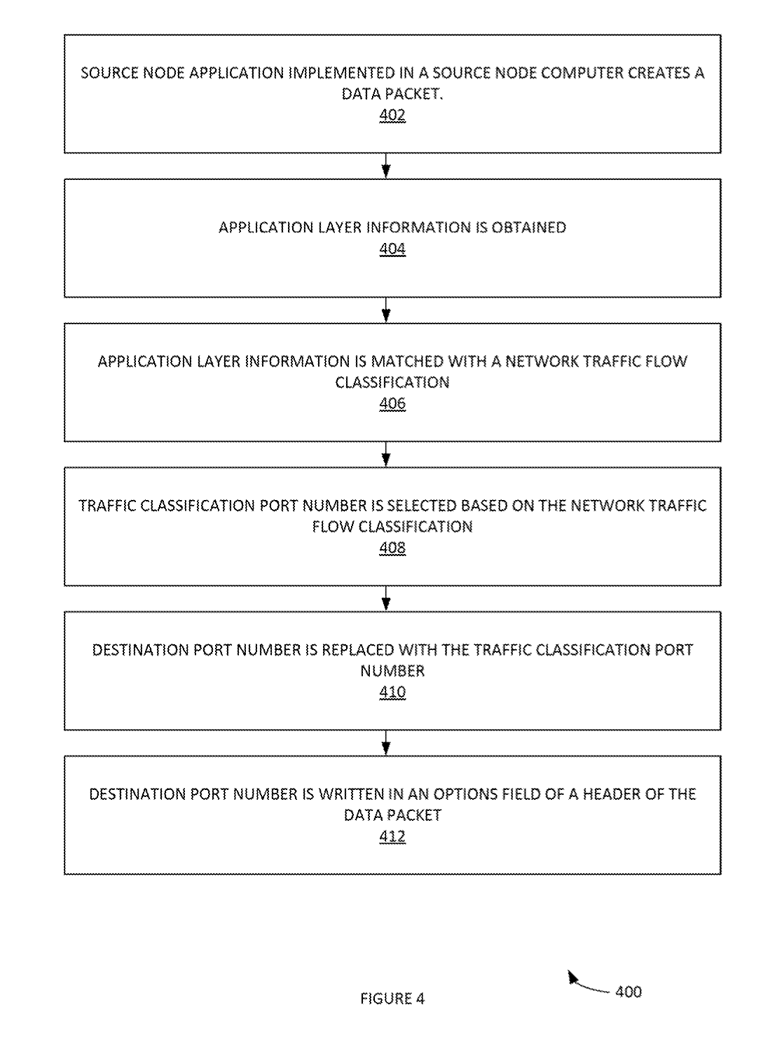

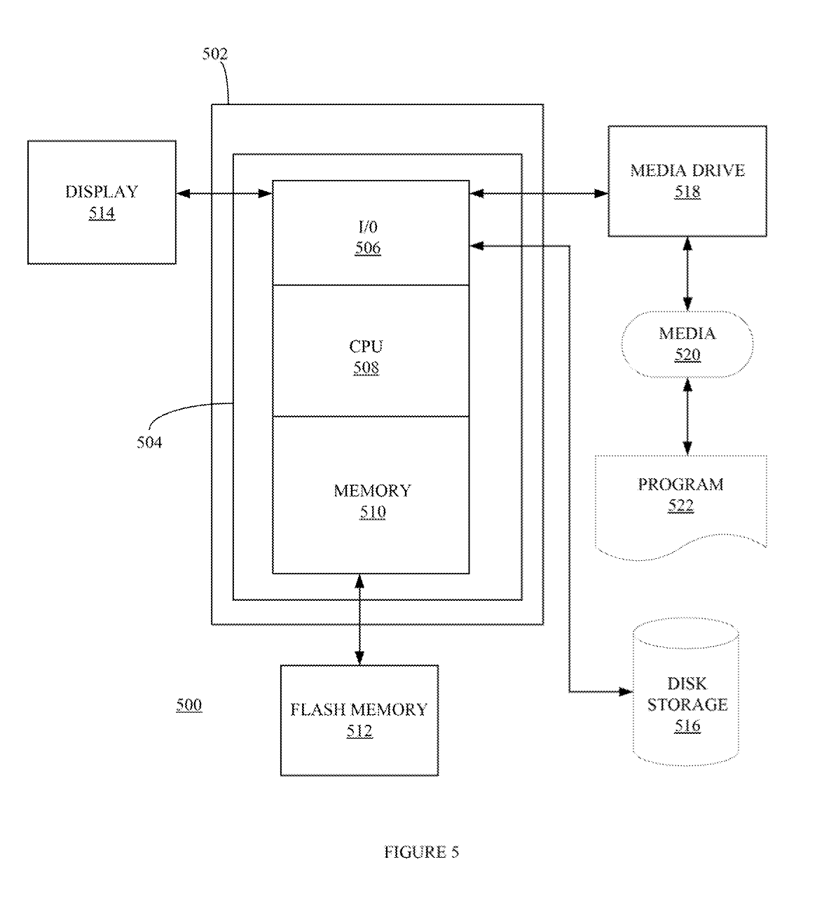

FIG. 4 depicts a process 400 of implementing one or more embodiments provided herein, according to some embodiments. In step 402, an application implemented in the source node creates a data packet. In step 404, application layer information is be obtained. In step 406, the application layer information is matched with a network traffic flow classification. For example, an administrator can create a set of network traffic flow classifications. Each network traffic flow classification can correspond to various network traffic flow options (e.g. a QoS value, a prioritization state, etc.) for the data packet. The network traffic flow classification can cause a configurable computer network to implement a classified traffic flow for the data packet based on the network traffic flow classification. In step 408, a traffic classification port number is selected based on the network traffic flow classification. Again, in some embodiments, an administrator can create a set of traffic classification port numbers that correspond to the various available network traffic flow classifications. Various examples of traffic classification port numbers have been provided herein under various identifiers such as the classification port number, quality of service classification port number and the like. In step 410, the destination port number is replaced with the traffic classification port number. In step 412, the destination port number is then written in an options field of a header of the data packet. It is noted, that some steps of process 400 can be repeated for each data packet in a particular network traffic flow in a computer network. Process 400 can be performed by another destination node computer in the configurable network to send data packets back to the source node computer. The destination node computer can replace the traffic classification port number with the original destination port number and forward the data packet to the destination port. It is noted that the traffic classification port number may not be a true ‘port’ number but rather a traffic classification signifier located destination port location of the data packet header. Process 400 can be implemented with the system and modules of FIGS. 3 and 5. It is noted that process 400 can be modified such that different types of applications/jobs can map to the same network traffic flow classification and different network traffic flow classifications can map to the same port.

FIG. 5 depicts an exemplary computing system 500 that can be configured to perform several of the processes provided herein. In this context, computing system 500 can include, for example, a processor, memory, storage, and I/O devices (e.g., monitor, keyboard, disk drive, Internet connection, etc.). However, computing system 500 can include circuitry or other specialized hardware for carrying out some or all aspects of the processes. In some operational settings, computing system 500 can be configured as a system that includes one or more units, each of which is configured to carry out some aspects of the processes either in software, hardware, or some combination thereof.

FIG. 5 depicts a computing system 500 with a number of components that can be used to perform any of the processes described herein. The main system 502 includes a motherboard 504 having an I/O section 506, one or more central processing units (CPU) 505, and a memory section 510, which can have a flash memory card 512 related to it. The I/O section 506 can be connected to a display 514, a keyboard and/or other attendee input (not shown), a disk storage unit 516, and a media drive unit 518. The media drive unit 518 can read/write a computer-readable medium 520, which can include programs 522 and/or data. Computing system 500 can include a web browser. Moreover, it is noted that computing system 500 can be configured to include additional systems in order to fulfill various functionalities. Display 514 can include a touch-screen system. In some embodiments, system 500 can be included in and/or be utilized by the various systems and/or methods described herein. As used herein, a value judgment can refer to a judgment based upon a particular set of values or on a particular value system.

It is noted that the methods and systems provided supra can be implanted in a data-center environment (e.g. with a host-to-host ‘east-west’ traffic pattern). For example, the data-center environment can span multiple datacenters with wide area network (WAN) links implemented between said datacenters. The data-center environment can be implemented in a cloud-computing environment and include various available scalable architectures. For example, a front-end server can ‘consult’ several other worker servers within the data-center environment before it returns an aggregated response back to a client. In some examples, the ‘east-west’ traffic can also be virtualization driven (e.g. with virtual servers syncing up with one another).

FIG. 6 shows the TCP header 600 and an expanded view of various sub-fields (e.g. options field 602) in the TCP options field of the TCP header, according to some embodiments. The TCP header 600 can describe such information as a data packet's source, destination, control information, etc. Options field 602 can be added to TCP header 600. Options field 602 consists of following sub-fields, an option-kind subfield 604, an option-length subfield 606, and/or an option data/padding subfield 608. Option-kind subfield 604 defines the type of option. Option-length subfield 606 defines the length of the option field. Option data/padding subfield 608 can be of variable length. Option data/padding subfield 608 can include the relevant data. The length of the options field 602 should be divisible by thirty-two (32). Accordingly, the option data/padding subfield 608 can include padding such that the length of the options field 602 is divisible by thirty-two (32).

In one example, the option-kind subfield 604 can be a specified length (e.g. one byte in length). The option-length subfield 606 can be two bytes. The option data/padding subfield 608 can be used to include the original destination port number. This may be included without the need for additional padding. These non-limiting examples are provided by way of example of not of limitation.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it may be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A method of managing computer network traffic flow quality of service comprising:
configuring a configurable network device to provide a specified quality of service to a data packet with a specified quality of service configuration based on a quality of service classification port number in a data packet header of the data packet;
at the source node, generating a data packet with a destination port number in the data packet header;
at the source node, replacing with the destination port number in the data packet header with a quality of service classification port number associated with the specified quality of service;
at the source node, including the destination port number in an options field of the data packet's header; and
communicating the data packet to the configurable network device.

2. The method of claim 1 further comprising:
at a destination node, receiving the data packet;
replacing the quality of service classification port number with the destination port number in the options field of the data packet header; and
forwarding the data packet to a destination process with the destination port number.

3. The method of claim 2, further comprising:
at the source node, segmenting the data packet into a set of data packet segments; and
replacing with the destination port number in a beginning section of each data packet segment with the quality of service classification port number associated with the specified quality of service.

4. The method of claim 3, further comprising:
at a destination node, receiving each data packet segment; and
replacing the quality of service classification port number with the destination port number in the options field of the beginning section of each data packet segment.

5. The method of claim 4, wherein the specified quality of service is based on information located in the networking headers of the data packet and the data itself.

6. The method of claim 5, wherein the information in the networking headers of the data packet comprises a Hadoop Distributed File System (HDFS) data, and wherein the HDFS data causes the data packet to assigned a specified quality of service.

7. The method of claim 5, wherein the information in the networking headers of the data packet comprises application awareness.

8. The method of claim 6, wherein a new option-kind is added to the TCP Options field. This new option-kind will be used to store the true destination port number.

9. A computerized system of managing computer network traffic flow quality of service comprising:
a processor configured to execute instructions;
a memory containing instructions when executed on the processor, causes the processor to perform operations that:
configure a configurable network device to provide a specified quality of service to a data packet with a specified quality of service configuration based on a quality of service classification port number in a data packet header of the data packet;
at the source node, generate a data packet with a destination port number in the data packet header;
at the source node, replace with the destination port number in the data packet header with a quality of service classification port number associated with the specified quality of service;
at the source node, include the destination port number in an options field of the data packet header; and
communicate the data packet to the configurable network device.

10. The computerized system of claim 9 wherein the memory containing instructions when executed on the processor, causes the processor to further perform operations that:
at a destination node, receive the data packet;
replace the quality of service classification port number with the destination port number in the options field of the data packet header, and
forward the data packet to a destination port with the destination port number.

11. The computerized system of claim 10 wherein the memory containing instructions when executed on the processor, causes the processor to further perform operations that:
at the source node, segment the data packet into a set of data packet segments; and
replace with the destination port number in a beginning section of each data packet segment with the quality of service classification port number associated with the specified quality of service.

12. The computerized system of claim 11 wherein the memory containing instructions when executed on the processor, causes the processor to further perform operations that:
at a destination node, receiving each data packet segment; and
replacing the quality of service classification port number with the destination port number in the options field of the beginning section of each data packet segment.

13. The method of claim 12, wherein the specified quality of service is based on information located in the networking headers of the data packet and the data itself.

14. The method of claim 13, wherein the information in the networking headers of the data packet comprises a Hadoop Distributed File System (HDFS) data, and wherein the HDFS data causes the data packet to assigned a specified quality of service.

15. The method of claim 14, wherein the information in the networking headers of the data packet comprises application awareness.

16. The method of claim 15, wherein a new option-kind is added to the TCP Options field. This new option-kind will be used to store the true destination port number.

17. A method comprising:
creating, with a source node application implemented in a source node computer, a data packet;
obtaining an application layer information about data in at least one application layer of the data packet;
matching the application layer information with a network traffic flow classification, wherein the network traffic flow classification causes a configurable computer network to implement a classified traffic flow for the data packet based on the network traffic flow classification;
selecting a traffic classification port number based on the network traffic flow classification;
replacing the destination port number with the traffic classification port number; and
writing the destination port number in an options field of a header of the data packet.

18. The method of claim 17 further comprising:
routing the data packet to the configurable computer network; and
providing instructions to a configurable networking device in the configurable computer network to route the data packet based on network traffic flow classifier.

19. The method of claim 17, wherein the network traffic flow classification comprises a quality of service classification for the data packet in the configurable computer network, and wherein the configurable networking device in the configurable computer network prioritizes the data packet based on the quality of service classification.

20. The method of claim 18, wherein the application layer information is obtained from the source node application and deep packet inspection of the data packet is not performed by the source node computer.
